(19) United States
(12) Patent Application Publication
(10) Pub. No.: US 2004/0233169 A1
(43) Pub. Date: Nov. 25, 2004

(54) Computer mouse

(76) Inventors: Boyd I. Willat, Los Angeles, CA (US); Adrian Cordova, San Diego, CA (US); Robert C. Portillo, Carlsbad, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/849,705

(22) Filed: May 19, 2004

Related U.S. Application Data
(60) Provisional application No. 60/473,250, filed on May 20, 2003.

(51) Int. Cl. G09G 5/08

(52) U.S. Cl. 345/163

(57) ABSTRACT

A computer mouse of improved ergonomic shape includes a resilient deformable cushion for supporting a user's hand and wrist, and shaped to minimize or eliminate neurological or repetitive motion disorders such as carpal tunnel syndrome. The cushion contains a flowable material such as a gel for compliant deformation in response to manual pressure, and a selected recovery time returning substantially to an initial nondeformed shape upon release of manual pressure. The cushion defines an upwardly exposed contoured surface extending over a tail region of the mouse to include a laterally spaced pair of raised landings for supporting the raised medial and lateral pads of the heel portion of the user's hand respectively overlying the trapezium and pisiform bones, in combination with an intervening recessed notch whereby the central carpal tunnel zone of the user's hand and wrist is comfortably suspended above the cushion in spaced relation therewith.

### BACKGROUND OF THE INVENTION

This application claims the benefit of U.S. Provisional Application No. 60/473,250, filed May 20, 2003.

This invention relates generally to improvements in a computer mouse used for operation and control of a computer. More particularly, this invention relates an improved computer mouse having an ergonomic shape in combination with a resilient deformable cushion, wherein the improved mouse is designed for comfortably supporting a user's hand in a manner substantially minimizing or eliminating neurological and/or repetitive motion disorders such as carpal tunnel syndrome and the like.

A computer mouse is generally known in the art for facilitated generation of operational and control commands delivered to a computer, such as a desktop computer or a laptop or notebook computer or the like. In general, the computer mouse comprises a relatively compact housing carrying a tracking device such as a rolling track ball or the like for rolling movement over a horizontal surface such as a so-called mouse pad placed onto a desktop surface or the like. Alternative tracking devices such as optical tracking systems are also known in the art. The tracking device monitors the direction and magnitude of movement of the computer mouse, and transmits appropriate responsive signals to a computer, for example, to control the position of a cursor or the like relative to a computer display screen. The mouse additionally includes one or more buttons positioned for convenient fingertip depression for sending additional commands to the associated computer. A rotary scroll wheel may also be provided on the mouse housing for fingertip rotary motion. The mouse is commonly connected to the computer by means of a hard wire connection, although wireless mouse-computer links are also available.

During normal use, a computer user typically places his or her hand over the mouse housing with the fingertips overlying the button or buttons and/or rotary scroll wheel mounted normally at a front or nose end of the mouse housing. This places the user's hand generally over the balance of the mouse housing, commonly in an orientation and position with the heel of the hand and/or a portion of the wrist pressed downwardly upon the adjacent horizontal surface such as a desktop surface or the like. In particular, this normally orients the user's hand in a position with the lateral pad and the heel of the hand overlying the pisiform bone pressed against the horizontal surface of the desktop or the like.

Prolonged use of the computer mouse, with the hand oriented and positioned as described, is known to contribute to an increasing incidence of neurological or repetitive motion disorders particularly such as carpal tunnel syndrome. In this regard, pressing the heel of the hand against a desktop surface while simultaneously manipulating the mouse in different directions over that surface in conjunction with frequent fingertip flexing to manipulate the pushbuttons and other mouse control elements places substantial stress on the so-called carpal tunnel region between the medial and lateral pads respectively overlying the trapezium and pisiform bones at the heel of the hand and adjoining region of the wrist. The wrist is defined by a plurality of small bones generally referred to as carpal bones, with the median nerve extending through the so-called carpal tunnel region located centrally between the trapezium and pisiform bones, and protected by an overlying fibrous ligament. The median nerve controls the motor and sensory functions of the thumb, index finger, and middle finger of the hand. Repetitive motion and flexing of the hand and fingers, in the course of manipulating a computer mouse, can often produce inflammation in the carpal tunnel region, resulting in the painful and frequently debilitating condition commonly known as carpal tunnel syndrome.

In attempts to reduce or alleviate incidence of carpal tunnel syndrome among computer users, the geometric shape of a computer mouse has evolved from initial simple rounded and somewhat half-ovoid shapes to more complex configurations including multiple surfaces and complex curvatures intended to be ergonomically and anatomically more compatible with the human hand and wrist. In some designs, the computer mouse has incorporated relatively soft surfaces formed from compliant materials such as resilient foam or gel. While such ergonomically designed mouse configurations and/or such resilient materials may provide some reduction in user fatigue and/or somewhat reduced incidence of neurological disorders, these problems have nevertheless continued to plague the computer industry.

There exists, therefore, an on-going need for further improvements in and to a computer mouse for the purposes of further alleviating and reducing hand and wrist fatigue attributable to prolonged use, and further in connection with significantly reducing and substantially eliminating neurological disorders such as carpal tunnel syndrome. The present invention fulfills these needs and provides further related advantages.

### SUMMARY OF THE INVENTION

In accordance with the invention, an improved computer mouse is provided with an improved ergonomic shape defined at least in part by a resilient deformable cushion for comfortably supporting a user's hand and wrist, while minimizing or eliminating neurological and/or repetitive motion disorders such as carpal tunnel syndrome and the like. The improved mouse incorporates a rear or tail region of shallow upwardly concave profile for comfortably supporting the heel and wrist portion of the user's hand. This tail region is defined by a laterally spaced pair of upstanding landings for supporting the raised medial and lateral pads of the hand heel portion, wherein these medial and lateral anatomical pads generally overlie the trapezium and pisiform bones, respectively. These raised landings are provided in combination with an intervening recessed pressure relief notch aligned generally with the carpal tunnel zone, when the medial and lateral pads of the hand and wrist are respectively supported on said landings, whereby the central carpal tunnel zone of the hand heel portion is suspended or spaced above the surface of the mouse during normal use. The deformable cushion extends over and defines the upwardly exposed surface of the tail region. In the preferred form, the cushion comprises a resilient bladder containing a flowable material such as a gel for compliant deformation in response to manual pressure, and a selected recovery time returning substantially to an initial nondeformed shape upon release of manual pressure.

More particularly, in accordance with one preferred form of the invention, the computer mouse includes a housing formed from molded plastic or the like, for supporting a position tracking device such as a conventional rolling track ball or an optical tracking system for monitoring the direction and magnitude of mouse movement over an underlying surface such as a desktop surface or the like. One or more upwardly exposed control buttons are disposed on a front or nose region of the mouse housing, and a rotatable scroll wheel may also be provided on the front housing region. This front region of the mouse housing may be provided with a relatively low profile configuration which merges rearwardly with an upwardly arched and generally convex central region for comfortably supporting the palm region of user's hand. This arched central region merges in turn with the tail region. The deformable cushion is mounted on the mouse housing to extend over at least the tail region thereof, and, in the preferred form, over at least a portion of the central arched region. An upper surface of the deformable cushion defines the raised landings spaced laterally by the central pressure relief notch.

The resilient bladder of the deformable cushion is filled or partially filled with the selected flowable material, such as a silicone-based liquid or gel or other suitable putty-like or gel-like or flowable particle substance of the type disclosed in U.S. Pat. No. 5,000,599 and U.S. Publication US 2003/0051316, published Mar. 20, 2003, which are incorporated by reference herein. In the most preferred form, the flowable material comprises an uncured liquid silicone composition with suitable additives for adjusting the viscosity in a manner whereby the flowable material readily deforms and conforms to a substantially customized anatomical contour in response to manual pressure, and substantially retains the deformed shape following release of manual pressure for a selected period of time preferably exceeding at least about three seconds or more, before relatively slow return movement or recovery to the initial nondeformed shape.

In use, the concavely profiled tail region of the computer mouse, defined by the raised landings of the deformable cushion, provides comfortable long-term cushioned support of the raised medial and lateral pads at the heel and wrist portion of the human hand. Accordingly, during use of the mouse, the heel and wrist portion of the hand is supported on the tail region of the mouse, and not upon the adjoining desktop surface or the like. Thus, as the mouse is movably deployed over the horizontal surface, the heel and wrist portions of the hand are moved with the mouse, and by contrast are thus not subjected to any significant pressure or stress. In addition, the raised medial and lateral landings are spatially separated by the intervening recessed pressure relief notch, resulting is suspending of the recessed carpal tunnel zone of the hand heel and wrist portion being spaced or suspended above the upper surface of the cushion. With this arrangement, the carpal tunnel zone of the hand and wrist does not contact and is not pressed against the computer mouse or any other support surface, whereby friction and pressure forces are not applied to the carpal tunnel zone during mouse usage. As a result, this carpal tunnel zone of the hand and wrist is not subjected to contact, pressure, or stress, and the incidence of related neurological and/or repetitive motion disorders such as carpal tunnel syndrome is substantially minimized or eliminated.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view illustrating the front, left and top sides of an ergonomic computer mouse in accordance with the present invention;

FIG. 2 is a top plan view thereof;

FIG. 3 is a right side elevation view thereof;

FIG. 4 is a rear end elevation view thereof; and

FIG. 5 is a somewhat schematic longitudinal sectional view showing mounting of the deformable cushion onto the mouse housing.

### DETAILED DESCRIPTION OF THE PREFERRED EMBODIMENT

As shown in the exemplary drawings, an improved ergonomic computer mouse referred to generally by the reference numeral 10 is provided with an improved ergonomic shape defined at least in part by a resilient deformable cushion 12 for comfortably supporting a user's hand and wrist, while minimizing or eliminating neurological and/or repetitive motion disorders such as carpal tunnel syndrome. The improved mouse 10 incorporates a rearward or tail region 14 defining a shallow upwardly concave profile for comfortably supporting the wrist and heel portion of the user's hand. This rear region includes a laterally spaced pair of upstanding landings 16 for supporting the raised medial and lateral pads 18 of the hand heel portion (shown in dotted lines in FIG. 4), in combination with an intervening recessed pressure relief notch 20 whereby the central carpal tunnel zone 22 of the hand heel portion is suspended or spaced above the surface of the mouse during normal use. The deformable cushion 12 extends over and defines the upwardly exposed surface of at least the tail region 14. The cushion comprises a resilient bladder containing a flowable material such as a gel for compliant deformation in response to manual pressure, and a selected recovery time returning substantially to an initial nondeformed shape upon release of manual pressure.

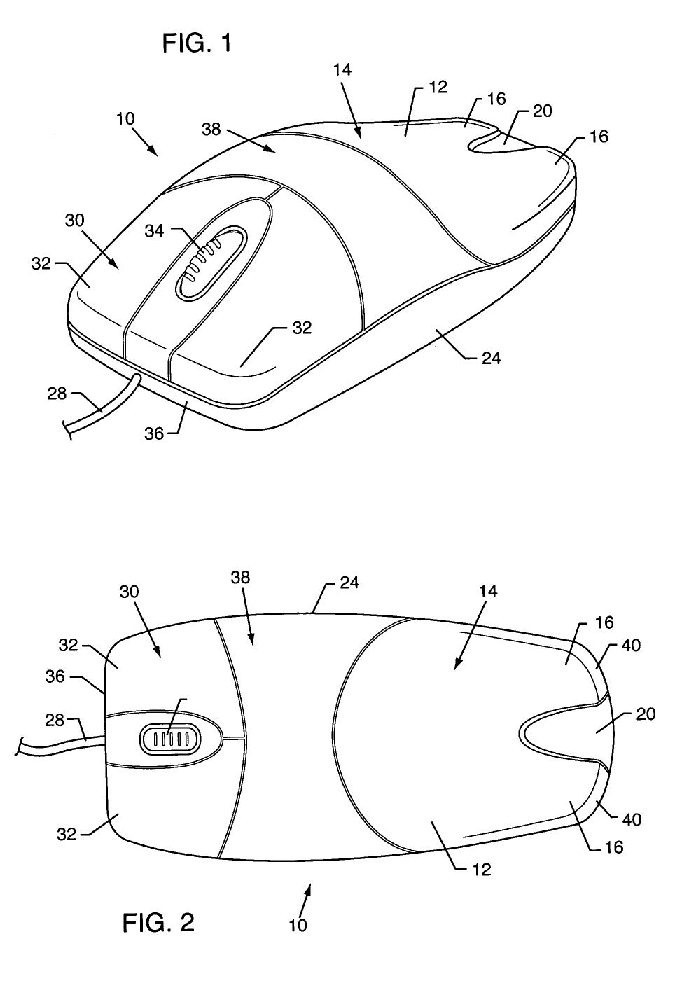

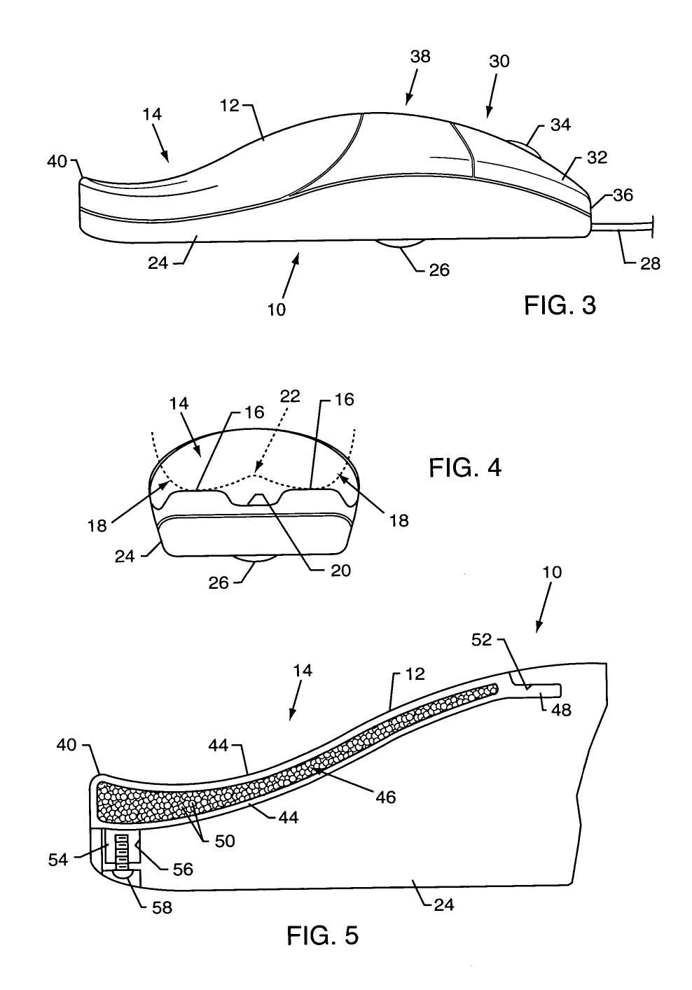

The illustrative computer mouse 10 includes conventional functional components for controlling and operating an associated computer (not shown) in a manner known in the art. In this regard, the mouse 10 comprises a contoured housing 24 formed from lightweight molded plastic of the like, and carries a position indicator means such as a track ball 26 (FIGS. 3-4) exposed partially at the underside thereof for rolling movement over a horizontal support surface, typically such as a mouse pad (also not shown) on a desktop or tabletop or the like. The track ball 26 is carried within the mouse housing 24 in a known manner by multiple tracking elements (not shown) for monitoring the direction and magnitude of ball rotation, and for appropriately signaling the associated computer by means of a conductor 28 (FIGS. 1-3) or other known signal transmission means such as a wireless mouse-computer link. In this regard, movement of the mouse 10 over a horizontal surface to cause rolling movement of the track ball 26 is commonly used for controlling the position of a cursor or the like on a computer display screen. Alternative position tracking devices such as an optical tracking system or the like may used for monitoring the direction and magnitude of mouse movement over an underlying desktop surface or the like.

The overall size and shape of the mouse 10 is suitable for convenient manual grasping, with the fingers of the hand extending over a forward or nose region 30 of the computer mouse 10. This nose region 30 of the mouse commonly includes additional control elements such as one or more upwardly exposed control buttons 32 used for sending additional control commands via the conductor 28 or other communication means to the associated computer. A rotary scroll wheel 34 may also be provided, as shown. This nose region 30 of the mouse housing is normally provided with a relatively low profile configuration tapering downwardly and forwardly toward a front nose end 36 of the mouse housing 24.

The forward or nose region 30 of the mouse housing merges rearwardly with a central region 38 forming an upwardly arched and generally convex profile (as viewed best in FIG. 3) for comfortably supporting the palm region of user's hand in a position with the fingers extending over the control buttons 32 and/or other control elements at the front of the mouse. This arched central region 38 merges downwardly and rearwardly in turn with the rear or tail region 14 of comparatively lower profile. In accordance with one aspect of the invention, the deformable cushion 12 is mounted on the mouse housing 24 to extend over at least the tail region 14, and, in the preferred form, over at least a portion of the central arched region 38 such as approximately the rearward one-half or one-third thereof.

An upper surface of the deformable cushion 12 defines the geometry of the tail region 14 for comfortably supporting the user's hand in the area of the heel portion and wrist. As viewed best in FIG. 3, this upper surface defined by the deformable cushion 12 has a shallow, upwardly concave profile for nested or seated reception of the wrist and heel portion of the user's hand. Importantly, the upper surface of the cushion 12 further defines the pair of laterally spaced or raised upstanding landings 16 (FIGS. 1-2 and 4) for comfortably supporting the raised pads 18 formed on the palmar side of the wrist and heel portion of the human hand generally at the medial and lateral sides thereof, and generally overlying the trapezium and pisiform bones, respectively. The somewhat concave geometry effectively provides a low profile raised lip 40 (FIG. 3) extending laterally across spaced laterally the rearmost end 42 of the mouse 10 to assist in locating and retaining the heel pads 18 of the wrist and hand on the raised landings 16, thereby elevating and supporting the wrist and heel portion of the user's hand on the mouse 10, and correspondingly preventing the computer user from pressing any portion of the wrist and hand heel portion against the flat desktop surface or the like adjacent the mouse 10. With the hand supported in this position and orientation, the palm portion is naturally draped over the central arched region 38, and the fingers are naturally extended over the control buttons 32 or other control elements on the nose region 30 of the mouse.

In accordance with a further important aspect of the invention, the raised landings 16 on the rearward region 14 are laterally spaced apart by means of the intervening recessed central pressure relief notch 20. This notch 20 is positioned to underlie the upwardly recessed carpal tunnel zone 22 (FIG. 4) formed between the raised pads 18 on the heel portion or carpal zone of the human hand and wrist, thereby effectively suspending or spacing the carpal tunnel zone 22 above the upper surface of the mouse 10 without physical contact therewith during normal use and operation. As a result, during such use, pressure and/or friction forces typically applied to the carpal tunnel zone 22 of the hand and wrist are avoided. Applicants have found that such pressure and/or friction forces are a major contributor to hand fatigue and also to neurological and/or repetitive motion disorders such as carpal tunnel syndrome. By providing the pressure relief notch 20 between the raised landings 16 upon which the wrist and heel portion of the hand is comfortably supported, applicants have found that user fatigue during prolonged mouse use is significantly alleviated, and further that the incidence of neurological and/or repetitive motion disorders such as carpal tunnel syndrome are greatly reduced and substantially eliminated.

Further enhanced user comfort with reduced fatigue is provided by the resilient deformable cushion 12 which produces a soft and pleasant tactile feel for comfortably supporting the user's hand. In a preferred form, the cushion comprises a hollow resilient bladder 44 formed from a suitable resilient or flexible elastomer to include a hollow interior 46 and a flange 48 (FIG. 5) at the forward margin thereof. The hollow interior 46 of the bladder 44 is filled or substantially filled with a selected flowable material 50 such as a gel or putty-like substance adapted for deformation to a custom-fitted anatomical shape in response to relatively low or lightweight application of manual pressure. In addition, the flowable material is preferably designed to retain the custom-fitted deformed shape for at least a significant time interval following release of the applied manual pressure, preferably at least about 3 seconds or more, followed by relatively slow return substantially to the initial nondeformed state.

A preferred gel material 50 for use in the bladder 44 comprises an uncured liquid silicone composition with suitable additives for adjusting the viscosity in a manner whereby the flowable material readily deforms and conforms to a substantially customized anatomical contour in response to manual pressure, and substantially retains the deformed shape following release of manual pressure for a selected period of time preferably exceeding at least about three seconds or more, before relatively slow return movement or recovery to the initial nondeformed shape. One alternative preferred material is shown and described in U.S. Pat. No. 5,000,599, which is incorporated by reference herein. Another alternative flowable material is shown and described in U.S. Publication US 2003/0051316, which is also incorporated by reference herein. A variety of other fluid and/or fluidized materials including liquids, colloid, gels, thermoplastic materials, and flowable particulate materials may be used.

As shown in FIG. 5, the bladder 44 may be mounted quickly and easily onto the mouse housing 24 by fitting the flange 48 at the forward margin of the bladder 44 into an undercut slot 52 formed in the central region 38 of the mouse housing. An enlarged boss 54 at a lower rear end of the bladder 44 is positioned for seated reception into a matingly shaped pocket 56 formed at the rear end of the housing 24, and a screw 58 or the like is fastened upwardly through a bore 60 into the boss 54 for retaining the bladder 44 in place. In addition, or alternatively, the lower portion of the bladder 44 may be suitably secured to the mouse housing 24 by means of a suitable adhesive or other suitable bonding means. By way of a further alternative bladder mounting arrangement, the lower portion of the bladder 44 may be comolded with the mouse housing 24 for secure adherence thereto, followed by injection of the flowable material 50 into the hollow interior 46 of the bladder 44. Other mounting arrangements including but not limited to snap-fit connections may also be used.

A variety of further modifications and improvements in and to the computer mouse 10 of the present invention will be apparent to those persons skilled in the art. Accordingly, no limitation on the invention is intended by way of the foregoing description and accompanying drawings, except as set forth in the appended claims.

What is claimed is:

1. A computer mouse, comprising:
a mouse housing including a nose region, a central region, and a tail region;
a deformable cushion extending over at least a portion of said tail region, said deformable cushion defining an upper surface for supporting the wrist and heel portion of a user's hand;
said upper surface of said deformable cushion further defining a recessed, substantially centrally located pressure relief notch positioned to underlie the upwardly recessed carpal tunnel zone of a user's supported hand and wrist, thereby spacing the carpal tunnel zone of a user's supported hand and wrist above said upper surface.

2. The computer mouse of claim 1 wherein said deformable cushion further defines a pair of laterally spaced landings for supporting the raised pads on the palmar side of the heel portion of a user's hand, said recessed pressure relief notch being formed between said pair of landings.

3. The computer mouse of claim 2 wherein said landings have an upwardly concave profile.

4. The computer mouse of claim 2 wherein said landings comprise raised portions of said upper surface.

5. The computer mouse of claim 1 wherein said deformable cushion further defines raised medial and lateral landings each having an upwardly concave profile and positioned for respectively supporting the medial and lateral pads on the palmar side of the heel portion of a user's hand, said recessed pressure relief notch being formed between said medial and lateral landings.

6. The computer mouse of claim 1 wherein said central region has an upwardly arched convex profile.

7. The computer mouse of claim 6 wherein said deformable cushion extends over said tail region and at least a rearward portion of said central region.

8. The computer mouse of claim 1 further including a position tracking device.

9. The computer mouse of claim 1 further including at least one control element.

10. The computer mouse of claim 1 further including signal transmission means for transmitting a control signal to a computer.

11. The computer mouse of claim 1 wherein said deformable cushion comprises a resilient hollow bladder having a flowable material contained therein.

12. The computer mouse of claim 11 wherein said flowable material comprises a gel.

13. The computer mouse of claim 11 wherein said flowable material is adapted for deformation in response to relatively lightweight manual pressure applied to said bladder, and for retaining a deformed shape upon release of applied manual pressure for a time interval of at least about three seconds before returning substantially to an initial nondeformed shape.

14. The computer mouse of claim 1 further including means for mounting said deformable cushion onto said mouse housing.

15. In a computer mouse including a mouse housing having a nose region, a central region, and a tail region, the improvement comprising:
a deformable cushion extending over at least a portion of said tail region, said deformable cushion defining an upper surface for supporting the wrist and heel portion of a user's hand;
said upper surface of said deformable cushion further defining a pair of laterally spaced landings for supporting the raised pads on the palmar side of the heel portion of a user's hand, and a recessed pressure relief notch positioned between said pair of pads to underlie the upwardly recessed carpal tunnel zone of a user's supported hand and wrist, thereby spacing the carpal tunnel zone of a user's supported hand and wrist above said upper surface.

16. The improvement of claim 15 wherein said landings have an upwardly concave profile.

17. The improvement of claim 16 wherein said landings comprise raised portions of said upper surface.

18. The improvement of claim 15 wherein said central region has an upwardly arched convex profile.

19. The improvement of claim 18 wherein said deformable cushion extends over said tail region and at least a rearward portion of said central region.

20. The improvement of claim 15 wherein said deformable cushion comprises a resilient hollow bladder having a flowable material contained therein.

21. The improvement of claim 20 wherein said flowable material comprises a gel.

22. The improvement of claim 20 wherein said flowable material is adapted for deformation in response to relatively lightweight manual pressure applied to said bladder, and for retaining a deformed shape upon release of applied manual pressure for a time interval of at least about three seconds before returning substantially to an initial nondeformed shape.

23. In a computer mouse including a mouse housing having a nose region, a central region, and a tail region, the improvement comprising:
an upper surface extending over at least a portion of said tail region for supporting the wrist and heel portion of a user's hand;
said upper surface defining a pair of laterally spaced landings for supporting the raised pads on the palmar side of the heel portion of a user's hand, and a recessed pressure relief notch positioned between said pair of pads to underlie the upwardly recessed carpal tunnel zone of a user's supported hand and wrist, thereby spacing the carpal tunnel zone of a user's supported hand and wrist above by said upper surface.

24. The improvement of claim 23 wherein said landings have an upwardly concave profile.

25. The improvement of claim 24 wherein said landings comprise raised portions of said upper surface.

26. The improvement of claim 23 wherein said raised pads are defined by at least one deformable cushion.

27. The improvement of claim 26 wherein said deformable cushion comprises a resilient hollow bladder having a flowable material contained therein.

28. The improvement of claim 27 wherein said flowable material comprises a gel.

29. The improvement of claim 27 wherein said flowable material is adapted for deformation in response to relatively lightweight manual pressure applied to said bladder, and for retaining a deformed shape upon release of applied manual pressure for a time interval of at least about three seconds before returning substantially to an initial nondeformed shape.

30. The improvement of claim 23 wherein said central region has an upwardly arched convex profile.
